(19) United States
(12) Patent Application Publication
(10) Pub. No.: US 2007/0242230 A1
(43) Pub. Date: Oct. 18, 2007

(54) Beam combiner for projection system

(75) Inventors: Yu-Chuan Chen, Taoyuan Hsien (TW); Shan-Feng Yen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/701,394

(22) Filed: Feb. 2, 2007

(30) Foreign Application Priority Data
Apr. 14, 2006 (TW) 95113309

(51) Int. Cl. G03B 21/00

(52) U.S. Cl. 353/33

(57) ABSTRACT

A beam combiner and a projection system are disclosed. The projection system includes at least two light sources, a beam combiner, a light tunnel, a light modulator, and a screen. The beam combiner includes at least two prisms. Each prism includes a reflective surface and at least a combining surface. The reflective surface is coated with a high reflective coating and each prism is combined with another prism at the combining surface. The light modulator produces image signal. Light produced from the at least two light sources is reflected by the beam combiner, and enters the light tunnel and the light modulator sequentially, and the screen receives the image signal from the light modulator.

### CROSS-REFERENCE TO RELATED APPLICATIONS

This application is related to U.S. Pat. No. 6,765,727 filed on Jun. 18, 2003, assigned to assignee of the present invention, and incorporated herein by reference.

### BACKGROUND OF THE INVENTION

1. Field of the Invention

The invention relates to a beam combiner, and in particular, to a beam combiner for a projection system.

2. Description of the Related Art

Present optical projection systems, such as projectors or projection televisions, project a single light beam to a light modulator. The light modulator arranges a light route for image signals in the projector system. For example, the digital micromirror device (DMD) is manufactured by Texas Instruments Inc. FIG. 1 is a schematic view of a conventional projector illumination system, wherein the light produced from a light source 12 is reflected by a reflective shell 24 and is gathered sequentially into a light tunnel 14 and the light modulator 10. The light passes through a lens 28, a prism 26, a digital micromirror device 20 and a prism 27 sequentially to project an image signal on the screen 22.

High quality projectors and projection televisions demand higher illumination. Thus, signal light sources consumed more power are used. Double light sources are also used to increase illumination and control costs.

A beam combiner is required to combine several light beams into the entrance of the light tunnel in a projector system having several light sources. As shown in FIG. 2, the beam combiner is a prism 13 comprising reflective surfaces 13a and 13b. Light produced by light sources 121 and 121′ is refracted respectively by the reflective surface 13a and 13b into the entrance of the light tunnel 14. Thus, light entering the light tunnel 14 can be accurately projected to an efficient area of the light modulator (not shown in FIG. 2) to enhance output intensity of light.

In a conventional technique, the reflective surfaces 13a and 13b are coated with a high reflective coating to form the reflective surface. During a coating process on one reflective surface, excessive coating easily accumulates on the other reflective surface when the angle between the reflective surface 13a and 13b is large. That is, the non-target surface is also partly coated. Thus, the uniformity of the two reflective surfaces is hard to control.

Additionally, to reflect light beam produced from two light sources, the prism 13 must bear high operating temperatures.

Thus, due to the drawbacks of the conventional technology, a beam combiner having uniform reflective surfaces is desirable.

### BRIEF SUMMARY OF THE INVENTION

Thus, the invention provides a beam combiner. The beam combiner comprises at least two prisms, wherein each prism respectively comprises a reflective surface coated with a highly reflective coating. The prisms are combined with each other by the non-reflective surfaces of each prism.

Accordingly, excessive coating remaining after the coating of each prism with a high reflective coating. After assembly, the excessive coating does not affect light passage. Thus, yield rate of the beam combiner can be increased.

The combination of the prisms is not limited to adhere all the non-reflective surfaces, another plate can also be adhered to each prism. The selected adhesive material must be capable of sustaining the operating temperatures of the beam combiner.

Furthermore, the prisms can also be combined by a clamp component.

Accordingly, the beam combiner can make the combination of difference sources by the reflective surfaces of the prisms, only the light route for the reflective surfaces needs to change, thus, it is unnecessary for refraction of an interior prism to change the light route.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional projection system;

FIG. 2 is a schematic view of a beam combiner of a conventional double-beam system;

FIG. 3 is a schematic view of an embodiment of a beam combiner of the invention;

FIG. 4 is a sectional view of the beam combiner of the invention shown in FIG. 3;

FIG. 5 is a schematic view of another embodiment of a beam combiner of the invention;

FIG. 6 is a sectional view of another embodiment of a beam combiner of the invention;

FIG. 7 is a top view of variant embodiment of a beam combiner; and

FIG. 8 is a beam combining system applied with the beam combiner of the invention.

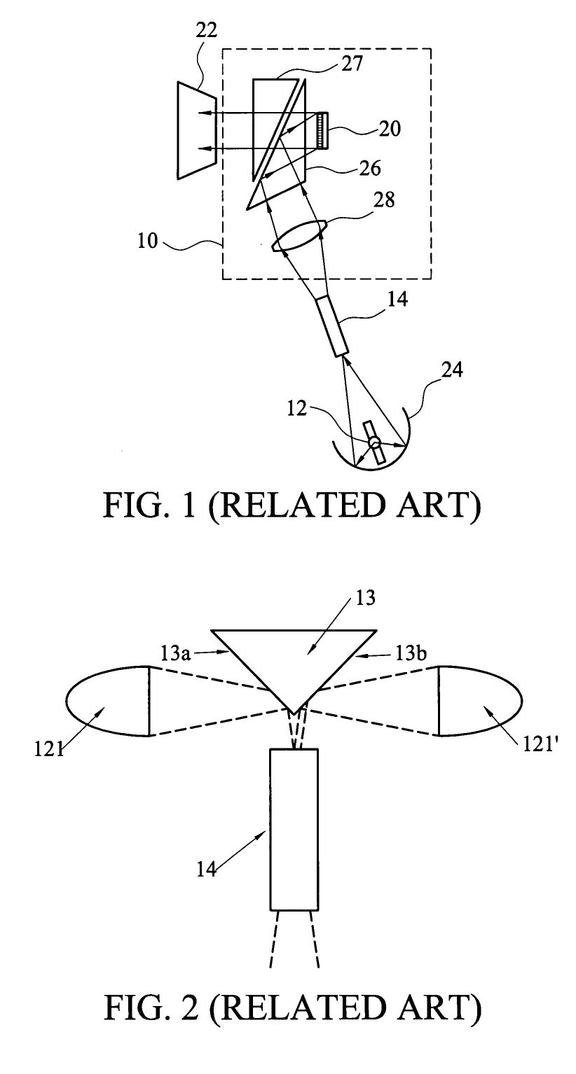

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

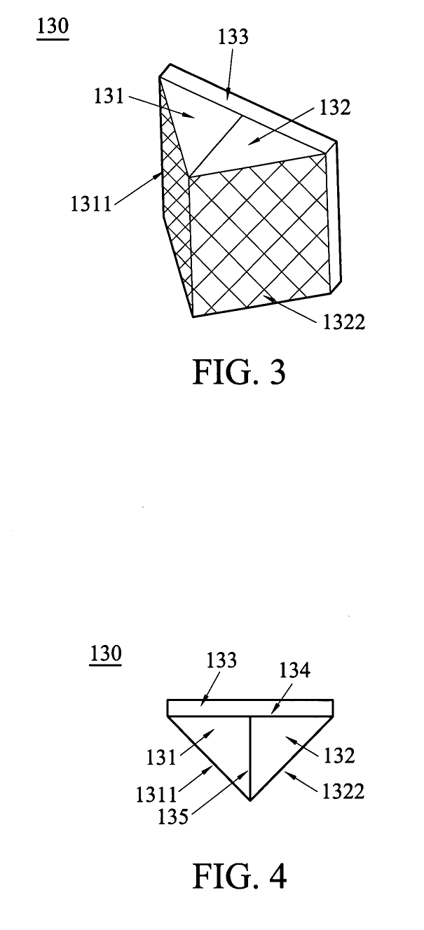

FIG. 3 is a schematic view which depicts a beam combiner 130 of an embodiment of the invention. The beam combiner 130 includes a prism 131 and a prism 132. In this embodiment, the prism is preferably a rectangular prism. The surfaces of each prism are polished to yield smooth surfaces. The prisms 131 and 132 respectively include a reflective surface 1311 and a reflective surface 1322 coated with a high reflective coating. When the reflective surface of the prism 131 is coated, excessive coating accumulation on other planes has no effect. In this embodiment, the prisms 131 and 132 are attached to a plate 133. The material of the plate 133 is not limited to glass. Other silicides, metal, or any material capable of combining the prisms 131 and 132 can also be used.

FIG. 4 is a sectional view of a beam combiner 130 shown in FIG. 3. A combining surface 135 is formed between the prism 131 and the prism 132. A combining surface 134 is formed between the plate 133, the prism 131 and the prism 132. The plate 133, the prisms 131 and 132 are joined by soldering, welding, or gluing (e.g. UV curing adhesives, silicone adhesives or ceramic adhesives) at the combining surface 134. Note that no joining means is provided at the combining surface 135, while gluing, soldering, or welding is performed thereat to join the prisms 131 and 132.

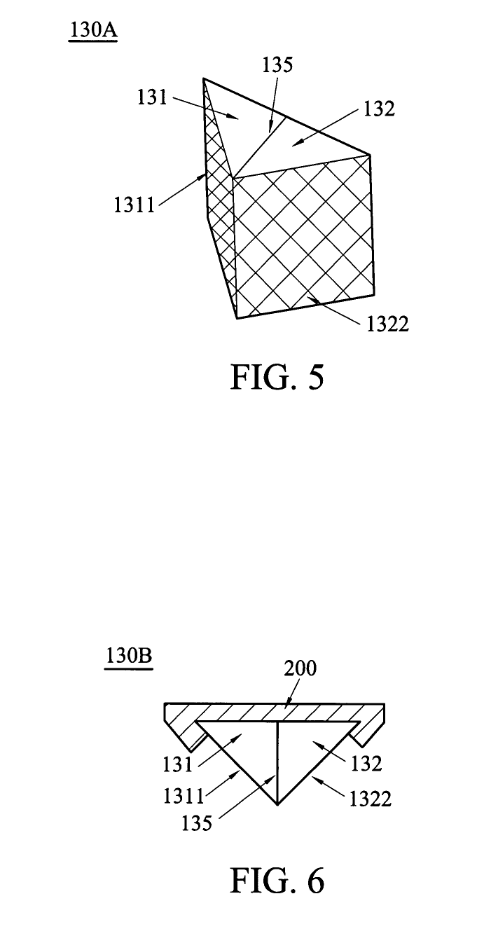

FIG. 5 is a schematic view which depicts another embodiment of a beam combiner 130A. The beam combiner 130A includes a prism 131 and a prism 132. The prisms 131 and 132 respectively include a reflective surface 1311 and a reflective surface 1322 coated with a high reflective coating. In the embodiment, each prism 131 and 132 respectively has a non-reflective surface to form a combining surface 135. In this embodiment, the combining surface 135 is combined with the prism 131 and the prism 132 by gluing, soldering, or welding.

FIG. 6 is a sectional view which depicts another embodiment of a beam combiner. The beam combiner 130B includes the prism 131 and the prism 132. The prism 131 and the prism 132 are combined by a clamp component 200. The prism 131 and the prism 132 respectively include a reflective surface 1311 and a reflective surface 1322. In the embodiment, the clamp component 200 can be a flexible metal piece, and the size of the clamp component 200 depends on not obstructing the function of the reflective surface 1311 and 1322. The combining method between the prisms is not limited to gluing, soldering, welding, or proceeding without any combination.

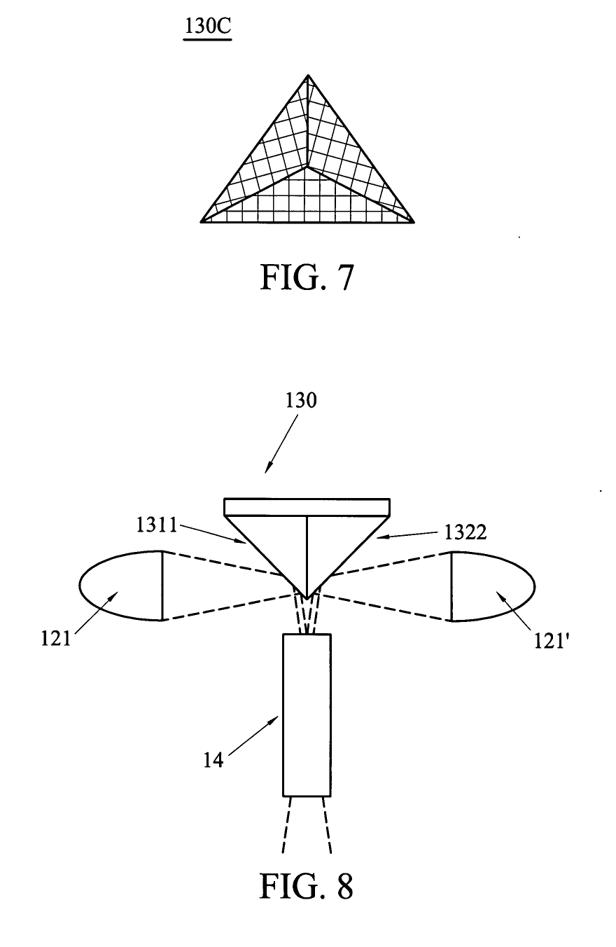

FIG. 7 is a top view of variant embodiment of a beam combiner. The embodiment of FIG. 7 shows a triangular pyramid 130C consisting of several prisms. Each surface of the triangular pyramid is coated with a high reflective coating capable of reflecting and concentrating light beams from three light sources. The combining method is not limited to gluing, soldering, welding, or combining by a clamp component (not shown).

In all embodiments, the angle between the reflective surfaces 1311 and 1322 is not limited. The angle, at which the light from different light sources is reflected by the reflective surface and enter the light tunnel 14, can be selected.

FIG. 8 is a schematic view of applying the beam combiner of the invention. In the FIG. 8, the beam combiner 130 shown in FIG. 3 is used as an example. Light beams of the light sources 121 and 121′ are refracted by the reflective surface 1311 and 1322 of the beam combiner 130, and combining into the light tunnel 14, for enhancing the intensity of the output light beam.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A beam combiner comprising:
a plurality of prisms, each of which comprises a reflective surface and at least a combining surface, wherein the reflective surface is coated with a high reflective coating and each prism is combined with another prism at the combining surface.

2. The beam combiner as claimed in claim 1, wherein the prisms are combined via the at least a combining surface combines the prisms by ultraviolet curing, gluing, soldering, welding, or adhesion.

3. The beam combiner as claimed in claim 1, further comprising a plate combined with the prisms by UV curing, gluing, soldering, welding, or adhesion.

4. The beam combiner as claimed in claim 3, wherein the plate is made of glass, metal, or silicide.

5. The beam combiner as claimed in claim 1, wherein each prism is a rectangular prism or an isosceles triangular prism.

6. The beam combiner as claimed in claim 1, further comprising a clamp for combining the prisms.

7. The beam combiner as claimed in claim 6, wherein the clamp is a flexible metal piece.

8. A projection system comprising:
at least two light sources;
a beam combiner comprising at least two prisms, each of which comprises a reflective surface and at least a combining surface, wherein the reflective surface is coated with a high reflective coating and the prisms are combined at the combining surface;
a light tunnel;
a light modulator for producing an image signal; and
a screen;
wherein light beams produced from the at least the two light sources are reflected by the beam combiner and enters the light tunnel and the light modulator, and the screen receives the image signal from the light modulator.

9. The projection system as claimed in claim 8, wherein at least a combining surface combines the prisms by ultraviolet curing, gluing, soldering, welding, or adhesion.

10. The projection system as claimed in claim 8, wherein the beam combiner further comprises a plate combined with the prisms by ultraviolet curing, gluing, soldering, welding, or adhesion.

11. The projection system as claimed in claim 10, wherein the plate is made of glass, metal, or silicide.

12. The projection system as claimed in claim 8, wherein each prism is a rectangular prism or an isosceles triangular prism.

13. The projection system as claimed in claim 8, wherein the beam combiner further comprises a clamp for combining the prisms.

14. The projection system as claimed in claim 13, wherein the clamp is a flexible metal piece.
